(19) United States
(12) Patent Application Publication
(10) Pub. No.: US 2026/0318683 A1
(43) Pub. Date: Oct. 15, 2026

(54) SURVEYING METHOD, SURVEYING SYSTEM, AND STORAGE MEDIUM

(71) Applicant: TOPCON CORPORATION, Tokyo (JP)

(72) Inventor: Hajime KAWASAKI, Tokyo (JP)

(73) Assignee: TOPCON CORPORATION, Tokyo (JP)

(21) Appl. No.: 19/466,801

(22) Filed: Feb. 2, 2026

(30) Foreign Application Priority Data
Feb. 4, 2025 (JP) 2025-016493

(51) Int. Cl. G01C 1/04; G01C 15/00

(52) U.S. Cl. CPC G01C 1/04; G01C 15/006

(57) ABSTRACT

Provided is a surveying method to be implemented by a system control unit 510 capable of communicating with multiple surveying instruments 10 and a terminal device 80, including: acquiring survey data from the multiple surveying instruments 10 and managing the survey data in a common coordinate system, the multiple surveying instruments installed at installation points that are arranged such that measurement ranges of adjacent ones of the surveying instruments have an overlapping region and so as to cover a survey area SA; taking the multiple surveying instruments 10 as a single virtual surveying instrument 100 having the whole measurement range of the multiple surveying instruments 10 as a virtual measurement range 200; and transmitting and receiving information to and from the terminal device 80 as the virtual surveying instrument 100 and utilizing the survey data managed in the common coordinate system to control the surveying instruments for surveying.

### TECHNICAL FIELD

The disclosure relates to surveying methods and more particularly, to surveying methods, surveying systems, and surveying programs using multiple surveying instruments.

### BACKGROUND ART

There has conventionally been known surveying method that employ a surveying system including: surveying instrument each configured to transmit distance-measuring light and receive reflected light to measure a distance and angle to a prism; and a terminal device configured to serve also as a controller for the surveying instrument.

Patent Literature 1 discloses a surveying method of sequentially measuring measurement points with a surveying instrument which automatically tracks a prism while an operator, holding a pole that supports the prism and a terminal device, moves within a survey area.

Surveying instruments also have specified measurement ranges within which they can operate with required measurement accuracies. The measurement ranges are set according to the performance of surveying instrument, that is, the reach limit of distance-measuring light and the detection limit of reflected light. Accordingly, using the above method requires to relocate the surveying instrument so that the measurement ranges partially overlap.

### CITATION LIST

### Patent Literature

Patent Literature 1: JP 2021/144003A1

### SUMMARY

### Technical Problem

Such a method, however, has a problem of poor efficiency due to the time and effort required for relocation of the surveying instrument.

The disclosure has been made in view of the above circumstances, and an object thereof is to provide a technique that enables efficient surveying of a large area.

### Solution to Problem

In order to achieve the foregoing object, an aspect of the disclosure provides a surveying method to be implemented by a system control unit including at least one electronic circuit and capable of communicating with multiple surveying instruments and a terminal device, the surveying method including the steps of: acquiring, by the system control unit, survey data from the multiple surveying instruments and managing the survey data in a common coordinate system, the multiple surveying instruments installed at installation points that are arranged such that measurement ranges of adjacent ones of the surveying instruments have an overlapping region and so as to cover a survey area including at least one measurement point; taking, by the system control unit, the multiple surveying instruments as a single virtual surveying instrument having the whole measurement range of the multiple surveying instruments as a virtual measurement range; and transmitting and receiving, by the system control unit as the virtual surveying instrument, information to and from the terminal device and utilizing the survey data managed in the common coordinate system to control the surveying instruments for surveying.

### BRIEF DESCRIPTION OF DRAWINGS

Various aspects and embodiments of the application will be described with reference to the following figures. Items appearing in multiple figures are indicated by the same or a similar reference number in all the figures in which they appear.

FIG. 1 is a schematic configuration diagram of a surveying system for implementing a surveying method according to an embodiment of the disclosure.

FIGS. 2A to 2G illustrate measurement ranges of the surveying system and survey areas.

FIG. 3 schematically depicts the internal structure of a surveying instrument that constitutes the surveying system.

FIG. 4 is a configuration block diagram of the surveying instrument.

FIG. 5 is a configuration block diagram of a system server that constitutes the surveying system.

FIG. 6 is a configuration block diagram of a terminal device that constitutes the surveying system.

FIG. 7 is a flowchart of processing by a first surveying method with the surveying system.

FIGS. 8A and 8B illustrate a method of setting instrument installation point for the surveying system.

FIGS. 9A and 9B briefly illustrate a second surveying method with the surveying system.

FIGS. 10A and 10B briefly illustrate the method.

FIG. 11 is a flowchart of processing by the system server when implementing the method.

FIG. 12 is a flowchart of processing by the surveying instrument when implementing the method.

FIG. 13 is a flowchart of processing by the terminal device when implementing the method.

FIGS. 14A and 14B depict screens displayed on a display unit of the terminal device when implementing the method.

FIG. 15 is a flowchart according to a variation of the first surveying method.

FIGS. 16A and 16B illustrate setting an arrangement of suitable installation points according to the variation.

### ADVANTAGEOUS EFFECTS OF INVENTION

The above configuration enables efficient surveying of a large area.

### DESCRIPTION OF EMBODIMENTS

Preferred embodiments of the disclosure will be described with reference to the accompanying drawings. The following description of the embodiments will include identical components designated by the same reference signs and equivalent functional components designated by the same names to omit redundant description as appropriate.

### EMBODIMENTS

### 1. Summary of Surveying System 1

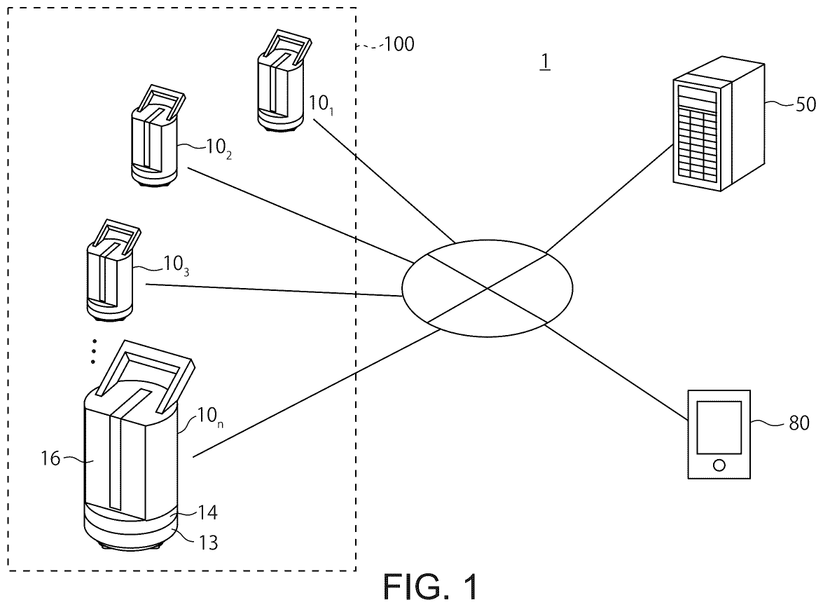

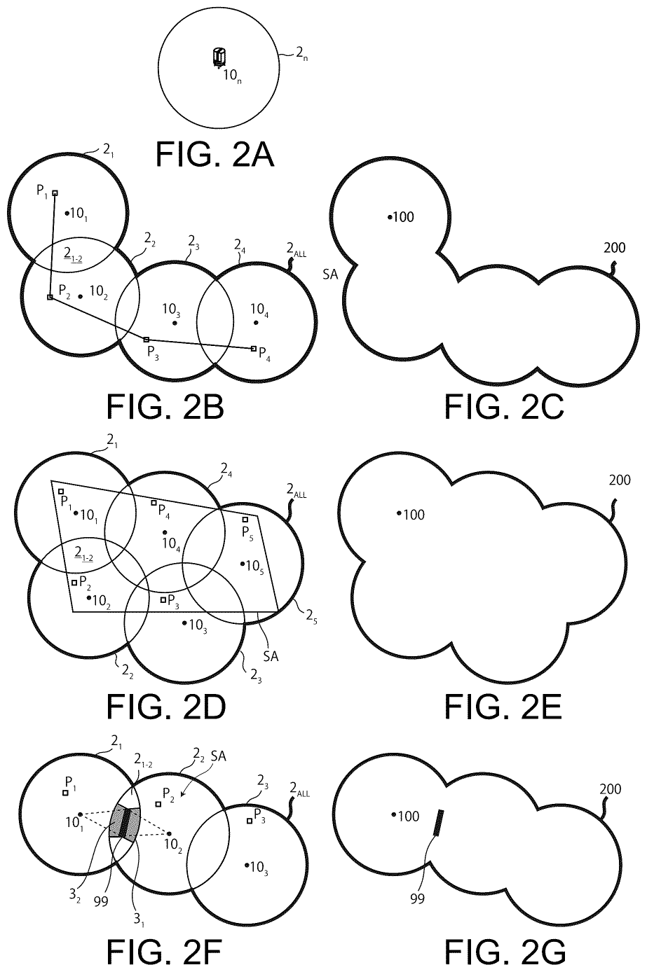

FIG. 1 is a schematic configuration diagram of a surveying system 1 for implementing a surveying method according to an embodiment. FIGS. 2A to 2G illustrate measurement ranges of the surveying system 1. The surveying system 1 includes multiple surveying instruments 10₁, 10₂, 10₃ . . . and a system server 50, and is used in conjunction with a terminal device 80. Any one of the multiple surveying instruments 10 (or each surveying instrument) will hereinafter be referred to as a surveying instrument 10ₙ (“n” represents a natural number), while all of the multiple surveying instruments will be referred to as multiple surveying instruments 10. Since each surveying instrument 10ₙ has the same mechanical configuration, only the surveying instrument 10ₙ is enlarged for the sake of explanatory convenience in FIG. 1. The number of surveying instruments 10ₙ is set arbitrarily according to a surveying operation target area (i.e. an area within which at least one measurement point is set; hereinafter referred to as a survey area) SA.

The surveying instruments 10ₙ is a ground-mounted motor-driven total station having an automatic tracking function. The system server 50 is a so-called computer. The terminal device 80 is a mobile computer terminal, such as a smartphone, a cell phone, a tablet, a Personal Digital Assistant (PDA), or a data collector, having a display. The multiple surveying instruments 10, the system server 50, and the terminal device 80 are capable of communicating with each other over a communication network such as the Internet.

As illustrated in FIG. 2A, the surveying instrument 10ₙ is specified with a measurement range 2ₙ, which is circular with the surveying instrument 10ₙ centered thereon in a plan view. The multiple surveying instruments 10 are arranged so as to cover the survey area SA with the measurement ranges (e.g. 2₁ and 2₂) of two adjacent surveying instruments (e.g. 10₁ and 10₂) having a mutually overlapping portion (overlapping region). In this case, as with conventional surveying, a line of sight must be ensured between the surveying instrument 10ₙ (for example, P₁ and 10₁, P₂ and 10₂). In particular, as illustrated in FIG. 2B, the surveying instruments 10ₙ may be arranged in a line. Alternatively, as depicted in FIG. 2D, one surveying instrument 10ₙ and two or more surveying instruments 10ₙ may be arranged to have an overlapping portion.

The survey area SA may be set as, for example, a line connecting all measurement points as depicted in FIG. 2B, or it may be set as an area including all measurement points as depicted in FIG. 2D. Alternatively, measurement points (P₁, P₂, P₃) per se may be set as a survey area SA, as depicted in FIG. 2F. It is noted that when a line connecting measurement points or a measurement points per se is set as a survey area SA, a tolerance (not depicted) may be set to allow for some deviation.

In FIGS. 2B and 2D, the entire survey area SA ensures a line of sight from at least one of the multiple surveying instruments 10. As depicted in FIG. 2F, even if an obstacle 99 may provide an out-of-sight area 3₁ from the surveying instrument 10₁ in the measurement range 2₁ and an out-of-sight area 3₂ from the surveying instrument 10₂ in the measurement range 2₂, it is only required to ensure a line of sight from at least one of the surveying instruments in the entire survey area SA or all measurement points.

The system server 50 is configured to take the multiple surveying instruments 10 as a single virtual surveying instrument 100 having the whole measurement range 2_{ALL} of the multiple surveying instruments 10 as a virtual measurement range 200 (see FIGS. 2C, 2E, 2G corresponding to FIGS. 2B, 2D, 2F, respectively). The system server 50 manages survey data from the multiple surveying instruments 10 as survey data in a common coordinate system and utilize the survey data to instruct the multiple surveying instruments 10, serving as the single virtual surveying instrument 100, to further input/output information to/from the terminal device 80. Each of the components will hereinafter be described in detail.

### 2. Surveying Instrument 10ₙ

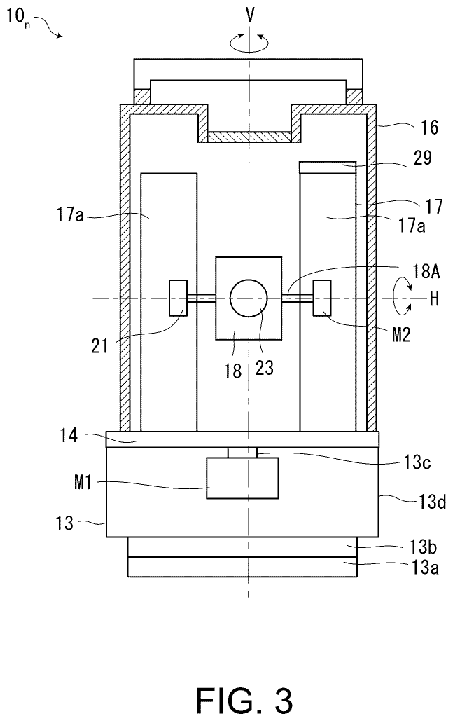

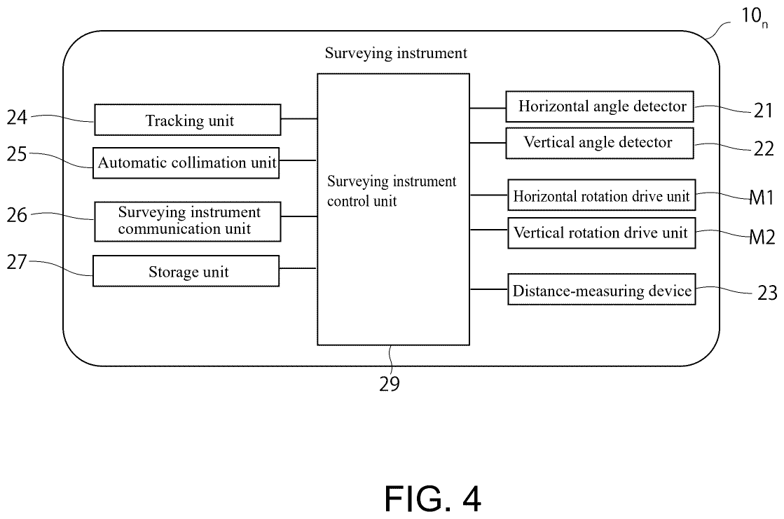

FIG. 3 schematically depicts the internal structure of the surveying instrument 10ₙ and FIG. 4 is a configuration block diagram. The surveying instrument 10ₙ includes a base portion 13, a rotary pedestal 14 configured to rotate horizontally with respect to the base portion 13, and a cover member 16 having an approximately cylindrical shape with a top surface and housing a surveying instrument body 15 therein. The surveying instrument body 15 includes a bracket portion 17 and a telescope 18.

The base portion 13 includes a fixed seat 13a to be fixed to a tripod (not depicted), a leveling base 13b having a leveling screw (not depicted), a rotary shaft 13c configured to cause the rotary pedestal 14 to rotate horizontally about an axis V, and a case 13d containing a drive mechanism such as a horizontal rotation drive unit M1 configured to rotationally drive the rotary shaft 13c. The rotary shaft 13c is provided with a horizontal angle detector 21 omitted in FIG. 3.

The bracket portion 17, which consists of a pair of left and right support members 17a, stands on the rotary pedestal 14. The telescope 18 is supported between the pair of support members 17a by a rotary shaft 18A so as to be vertically rotatable about an axis H. The rotary shaft 18A has one end portion to which a vertical rotation drive unit M2 is fixed with and the other end portion provided with a vertical angle detector 22.

The right support member 17a supports a surveying instrument control unit 29 mounted on a control circuit board on the top thereof. The cover member 16 has a band-shaped telescope window 16b extending from the upper surface to a boundary portion with the rotary pedestal 14 in the center of the front surface thereof. The telescope window 16b is formed on the collimation axis of the telescope 18 and configured to transmit distance-measuring light from a distance-measuring device 23 and tracking light from a tracking unit 24.

The surveying instrument 10 comprises the horizontal angle detector 21, the vertical angle detector 22, the horizontal rotation drive unit M1, the vertical rotation drive unit M2, the distance-measuring device 23, the tracking unit 24, an automatic collimation unit 25, a surveying instrument communication unit 26, a surveying-instrument storage unit 27, and the surveying instrument control unit 29.

The horizontal angle detector 21 and the vertical angle detector 22 are each implemented using an absolute encoder or an incremental encoder. The horizontal angle detector 21 is configured to detect the horizontal angle of the rotary pedestal 14, that is, the horizontal angle of the telescope 18. The vertical angle detector 22 is configured to detect the vertical angle of the telescope 18. The horizontal rotation drive unit M1 and the vertical rotation drive unit M2 are each implemented using a motor. The horizontal rotation drive unit M1 is configured to drive the rotary shaft 13c and the vertical rotation drive unit M2 is configured to drive the rotary shaft 18A. These drive units are configured to cooperate to horizontally and vertically rotate the telescope 18, that is, the optical axis of distance-measuring light. In the following description and the claims, the horizontal angle detector 21 and the vertical angle detector 22 will be referred to collectively as an angle detector, and the horizontal rotation drive unit M1 and the vertical rotation drive unit M2 will be referred to collectively as a rotary drive unit.

The distance-measuring device 23 is an electronic distance meter including: a light transmitting unit, which has a light emitting element such as a laser diode; a distance-measuring optical system; and, a light receiving unit, which has a light receiving element such as an avalanche photodiode. The distance-measuring device 23 is stored within the telescope 18 such that the distance-measuring optical axis coincides with the collimation axis of the telescope 18. The distance-measuring device 23 is configured to emit distance-measuring light, which is infrared or visible laser light from the light transmitting unit, through the distance-measuring optical system toward a measuring target, that is, a prism 8, and then receive reflected light with the light receiving unit to measure the distance to the measuring target based on a phase or time difference between the distance-measuring light and internal reference light.

The tracking unit 24 includes a tracking light transmitting unit having a light emitting element such as a laser diode, a tracking optical system that shares some components with the distance-measuring optical system, and an imaging element configured to receive reflected tracking light. The imaging element may be implemented using a sensor such as a Charge-Coupled Device (CCD) sensor or a Complementary Metal-Oxide-Semiconductor (CMOS) sensor. The tracking unit 24 includes the surveying instrument control unit 29 and the rotary drive unit, and is configured to emit, in the optical axis direction of the distance-measuring light, as tracking light, visible or infrared laser light with a wavelength different from that of the distance-measuring light to acquire images in the collimation direction when the tracking light is on and off. The surveying instrument control unit 29 is configured to: obtain the center of the image of the prism 8 based on a difference between the acquired images; and calculate its position. The surveying instrument control unit 29 is configured to then drive the rotary drive unit such that the gap between the center of the prism 8 and the collimation axis of the telescope 18 is within a certain value to cause the telescope 18 to always face the prism 8. The tracking unit 24 is also configured to perform a prism search function of driving the rotary drive unit to rotate the telescope 18 to lock onto the prism 8.

The automatic collimation unit 25 includes: a collimation-light transmitting unit which has a light emitting element such as a laser diode; a collimation optical system that shares some components with the distance-measuring optical system; and an imaging element such as a CCD sensor or a CMOS sensor. The automatic collimation unit 25 also includes the surveying instrument control unit 29 and the rotary drive unit, and is configured to emit collimation light from the collimation-light transmitting unit and receive reflected collimation light from the prism 8, which is a target, at the imaging element and, based on the result of receiving light, perform automatic collimation in which the collimation optical axis is aligned with the prism 8.

The surveying-instrument communication unit 26 is a communication interface that enables transmission and reception of information to and from the system server 50. Communication means may be implemented using known wired and wireless communication methods, such as Wi-Fi, Bluetooth (registered trademark), infrared communications, and mobile communication networks. The surveying instrument 10ₙ is configured to transmit, via the surveying instrument communication unit 26 to the system server 50, survey data such as position information of the prism 8 being tracked and measurement results, and receive instructions from the system server 50.

The surveying instrument storage unit 27 is a non-transitory computer readable storage medium such as a Hard Disc Drive (HDD), a Solid-State Drive (SSD), or a flash memory. The surveying instrument storage unit 27 stores programs for performing various functions of the surveying instrument control unit 29. The surveying instrument storage unit 27 may store survey data acquired by the surveying instrument 10ₙ.

The surveying instrument control unit 29 includes at least one electronic circuit and at least one memory. The electronic circuit may employ a processor such as a Central Processing Unit (CPU). The memory may employ a memory device such as a Static Random-Access Memory (SRAM) or a Dynamic Random-Access Memory (DRAM). When a CPU is used, the surveying instrument control unit 29 is configured such that the CPU reads out and executes programs for performing the functions in the memory and performing the functions of the surveying instrument control unit 29.

The surveying instrument control unit 29 may be partially configured in hardware such as a Complex Programmable Logic Device (CPLD) and/or a Field Programmable Gate Array (FPGA). When a CPLD and/or an FPGA are used, circuits configured on the elements achieve their respective functions. That is, the surveying instrument control unit 29 may include a processor for achieving functions in software and a circuit for achieving functions in hardware.

The surveying instrument control unit 29 is connected to each of the angle detector, the rotary drive unit, the distance-measuring device 23, the tracking unit 24, the surveying instrument communication unit 26, and the surveying instrument storage unit 27 for control to perform the functions of the surveying instrument 10ₙ and for input/output of information.

The surveying instrument control unit 29 is configured to perform a surveying function of controlling the angle detector, the rotary drive unit, the horizontal rotation drive unit M1, the vertical rotation drive unit M2, and the distance-measuring device 23, to measure the distance and angle to the prism 8. Specifically, the surveying instrument control unit 29 is configured to measure the distance and angle to the prism 8 according to an instruction from the system server 50 and output measurement data to the system server 50 via the surveying-instrument communication unit 26.

The surveying instrument control unit 29 is configured to control emission of tracking light to obtain the center of the image of the prism 8 based on a difference between images when the tracking light is on and off, which are output from the tracking unit 24, and calculate the position (center) of the prism 8. The surveying instrument control unit 29 is configured to then drive the rotary drive unit such that the gap between the center of the prism 8 and the center of the axis of sight of the telescope 18 is within a certain value for automatic tracking in which the telescope 18 always faces the prism 8.

The above-described example provides a configuration of the surveying instrument 10ₙ using a total station with the cover member 16 that houses the surveying instrument body 15, however, the configuration is not limited thereto and may employ a conventional total station without the cover member 16 or a ground-mounted scanner having a target scanning function.

### 3. System Server 50

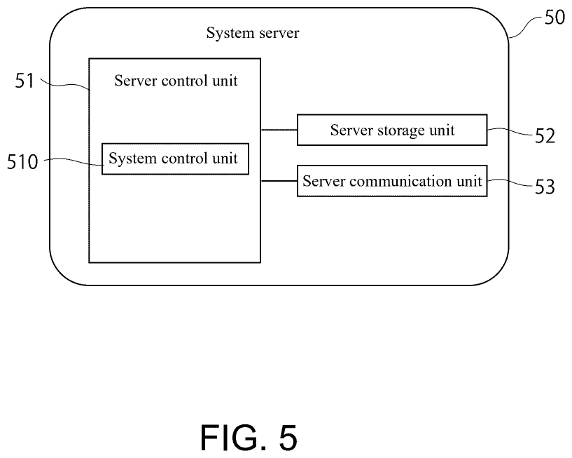

FIG. 5 is a block diagram of the system server 50. The system server 50 includes at least a server control unit 51, a server storage unit 52, and a server communication unit 53. In addition, The system server 50 may include an input unit such as a keyboard and/or a display unit such as a liquid crystal display, though not depicted. Alternatively, the terminal device 80 may achieve the functions of the input unit and/or the display unit.

The server control unit 51 includes at least one electronic circuit and at least one memory. The electronic circuit employs a processor such as a CPU, for example. The memory employs a memory device such as an SRAM or a DRAM, for example. When the electronic circuit employs a CPU, the server control unit 51 is configured such that the CPU reads out and executes a program for performing the functions in the memory and performing the functions of the server control unit 51.

The server control unit 51 includes a system control unit 510 as a functional unit. The system control unit 510 is configured to treat multiple surveying instruments 10, which are installed so as to have overlapping measurement ranges, as a single virtual surveying instrument 100 having a virtual measurement range 200 that is the whole overlapping measurement range 2_{ALL} and, as the virtual surveying instrument 100, communicate information with the terminal device 80. The system control unit 510 manages survey data from the multiple surveying instruments 10 in a common coordinate system and output to the terminal device 80. The system control unit 510 also receives an instruction for the virtual surveying instrument 100 from the terminal device 80 and converts it into an instruction for each surveying instrument 10ₙ for surveying.

The server storage unit 52 is implemented using a non-transitory computer readable storage medium such as an HDD or an SDD. The server storage unit 52 stores programs for performing functions of the system control unit 510.

The server communication unit 53 is a communication interface equivalent to the surveying instrument communication unit 26. The server communication unit 53 enables communication between the system server 50 and the multiple surveying instruments 10 as well as the terminal device 80.

It is noted that the system server 50 may employ a so-called personal computer or a cloud computer.

### 4. Terminal Device 80

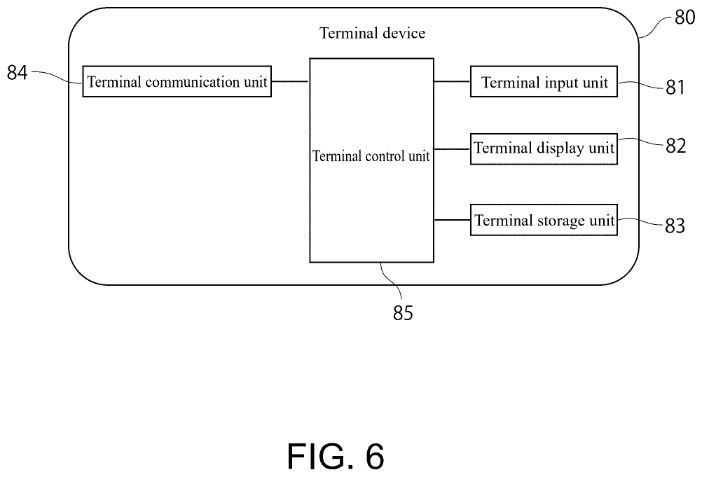

FIG. 6 is a block diagram of the terminal device 80. The terminal device 80 is configured to communicate with the system server 50, which serves as the virtual surveying instrument 100, acquire and display data from the virtual surveying instrument 100, and remotely operates the virtual surveying instrument 100. The terminal device 80 includes a terminal input unit 81, a terminal display unit 82, a terminal storage unit 83, a terminal communication unit 84, and a terminal control unit 85.

The terminal input unit 81 and the terminal display unit 82 serve as a user interface of the terminal device 80. An operator OP can input an operational instruction for the virtual surveying instrument 100 and/or information through the terminal input unit 81. The terminal display unit 82 is a touch-panel liquid crystal display integrated with the terminal input unit 81. The configuration is not limited thereto, and the terminal input unit 81 and the terminal display unit 82 may be separate components. The terminal display unit 82 is configured to display survey data received from the virtual surveying instrument 100 and measurement screens of the virtual surveying instrument 100, etc.

The terminal storage unit 83 is a non-transitory computer readable storage medium such as a flash memory, an HDD, or an SDD. The terminal storage unit 83 stores various programs for performing functions of the terminal device 80. The terminal storage unit 83 stores application programs configured to enable transmitting and receiving data to and from the system server 50, which serves as the virtual surveying instrument 100, to remotely operate the virtual surveying instrument 100 and to acquire data from the virtual surveying instrument 100 so as to display survey data and/or survey assistance screens. The terminal storage unit 83 may store survey data acquired from the system server 50.

The terminal communication unit 84 is a communication interface equivalent to the surveying instrument communication unit 26, which enables transmitting and receiving information to and from the system server 50.

The terminal control unit 85 includes at least one electronic circuit and at least one memory. The electronic circuit employs a processor such as a CPU. The memory employs a memory device such as an SRAM or a DRAM.

The terminal control unit 85 is configured to execute the application program to display survey data of the virtual surveying instrument 100 from the system server 50 on the terminal display unit 82 and to transmit an operator's instruction input via the terminal input unit 81 to the system server 50.

### 5. First Surveying Method

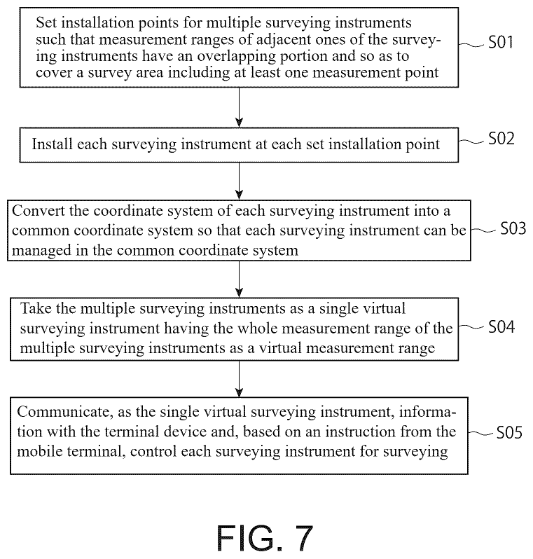

FIG. 7 is a flowchart of a first surveying method, which is an example of a surveying method with the surveying system 1.

First, installation points for multiple surveying instruments 10 are set (arranged) at a survey site such that measurement ranges of adjacent ones of the surveying instruments have an overlapping region and so as to cover a survey area including at least one measurement point. At this time, a line of sight between the measurement point and each surveying instrument 10ₙ is considered as in the case with common surveyance (S01).

An operator OP then installs each surveying instrument 10ₙ at each respective installation point and acquires the coordinates of each installation point by a method such as backward intersection (S02).

Next, the system control unit 510 converts the coordinate system of each surveying instrument 10ₙ into a common coordinate system so as to manage the multiple surveying instruments 10 in the common coordinate system (S03). To achieve this, the system control unit 510 is connected to the multiple surveying instruments 10 to acquire an ID, the coordinates of each instrument installation point, and the direction angle of each surveying instrument 10ₙ, from each surveying instrument 10ₙ. This enables the system control unit 510 to manage survey data acquired from each surveying instrument 10ₙ in the common coordinate system in association with the ID of each surveying instrument 10ₙ and convert the survey data into data for the virtual surveying instrument 100 for outputting to the terminal device, and convert an instruction for the virtual surveying instrument 100 into an instruction for each surveying instrument 10ₙ for surveying. The common coordinate system may be, for example, a local coordinate system of any one of the multiple surveying instruments 10 or an absolute coordinate system.

The system control unit 510 then takes the multiple surveying instruments 10 as a single virtual surveying instrument having a virtual measurement range 200 that is the whole measurement range 2_{ALL} of the multiple surveying instruments 10 (S04).

The system control unit 510 then communicates, as the single virtual surveying instrument 100, information with the terminal device 80 and utilizes the survey data managed in the common coordinate system to control each surveying instrument 10ₙ for surveying (S05).

The surveying method described above can eliminate the need for relocation of the surveying instrument 10ₙ to survey an area larger than the measurement range 2ₙ of each surveying instrument 10ₙ. This configuration also enables exchange of information between the terminal device 80 with the multiple surveying instruments taken collectively as a single virtual surveying instrument. This eliminates the need for development of an application program for the terminal device 80 that supports multiple surveying instruments and thus enables surveying using a conventional application program for a single surveying instrument 10ₙ.

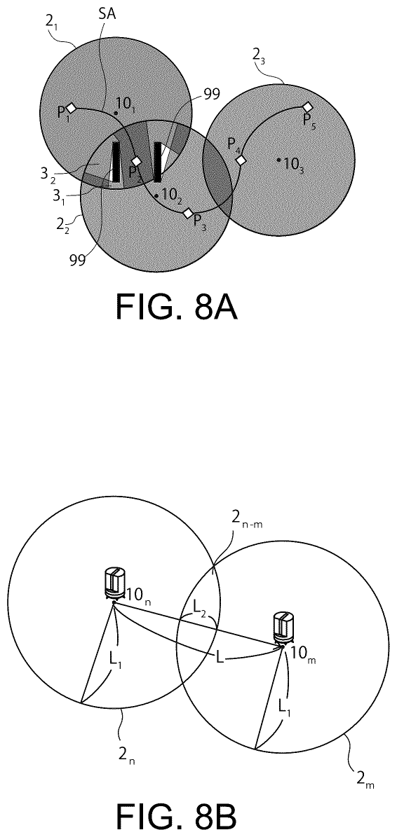

As described above, in the first surveying method, the installation points of multiple measuring instruments are set such that the survey area SA or each measurement point is ensured line of sight from at least one of the surveying instruments. However, when surveyance utilizing an automatic tracking function, as described in a second surveying method below, the following additional conditions are required. That is, lines of sight with two or more of the surveying instruments are ensured in at least a portion of the overlapping region of the measurement ranges of adjacent ones of the multiple surveying instruments. The survey area SA is also set as a line connecting all measurement points or as an area including all measurement points. That is, as depicted in FIG. 8A, even if obstacles 99 may provide an out-of-sight area 3₁, 3₂ from one of the surveying instruments and/or an out-of-sight area from both of the surveying instruments, it is only required that lines of sight with two or more of the surveying instruments are ensured in at least a portion of the overlapping region. It is noted that even if three or more surveying instruments 10ₙ may be involved in the overlapping region, it is only required that lines of sight with two or more of the surveying instruments 10 are ensured.

It is also preferred that the amount of overlapping is set in view of the moving speed of the operator OP holding the prism 8. To explain this with reference to FIG. 8B, the distance L between two adjacent surveying instruments 10ₙ and 10ₘ is required to satisfy the following Formula 1 with respect to the radius L₁ of measurement ranges 2ₙ and 2ₘ set for the surveying instruments 10ₙ and 10ₘ and the overlapping radial distance L₂:

L<L₁×2−L₂×2 (Formula 1),

where L₂ represents the distance that the operator OP holding the prism 8 moves during a period of time required for the tracking unit 24 of the surveying instrument 10ₙ to lock onto the prism 8. For example, when the moving speed of the operator OP is 5 km/hour and the required period of time is 5 seconds, the distance is 7 m. When the radius of the measurement range 2ₙ is 130 m, the distance L between the two adjacent surveying instruments 10ₙ and 10ₘ has a maximum value of 246 m in straight-line distance. This enables the surveying instrument 10ₙ to reliably lock onto the prism 8 in the overlapping region 2ₙ₋ₘ of the measurement ranges with the adjacent surveying instrument 10ₘ.

### 6. Second Surveying Method

Another example of the surveying method will be described, which is implemented in the step S05 of the first surveying method. The second surveying method includes, during measurement, an operator OP moving within a survey area while holding a pole 9 with a prism 8 and a terminal device 80. The prism 8 is preferably an all-around prism configured to reflect light incident in any direction of the entire circumference (360 degrees) along the incident direction. The prism 8 is provided such that the central axis of the pole 9 passes through the optical center thereof. The prism 8 is mounted at a known height. The operator OP moves while holding the pole 9 vertically. At a measurement point the operator OP brings the lower end of the pole 9 into contact with the ground and causes a surveying instrument 10 to measure the prism 8 to acquire the coordinates of the measurement point.

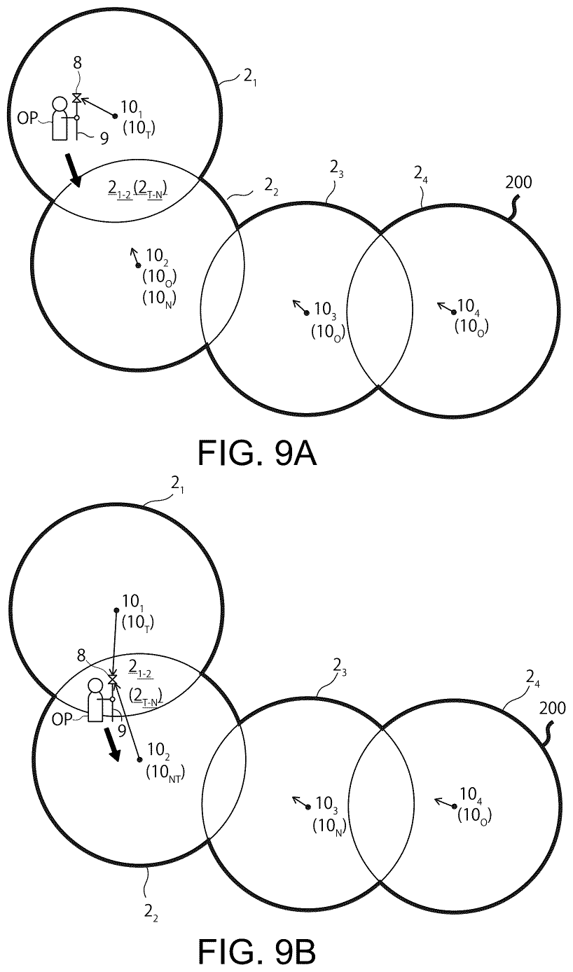

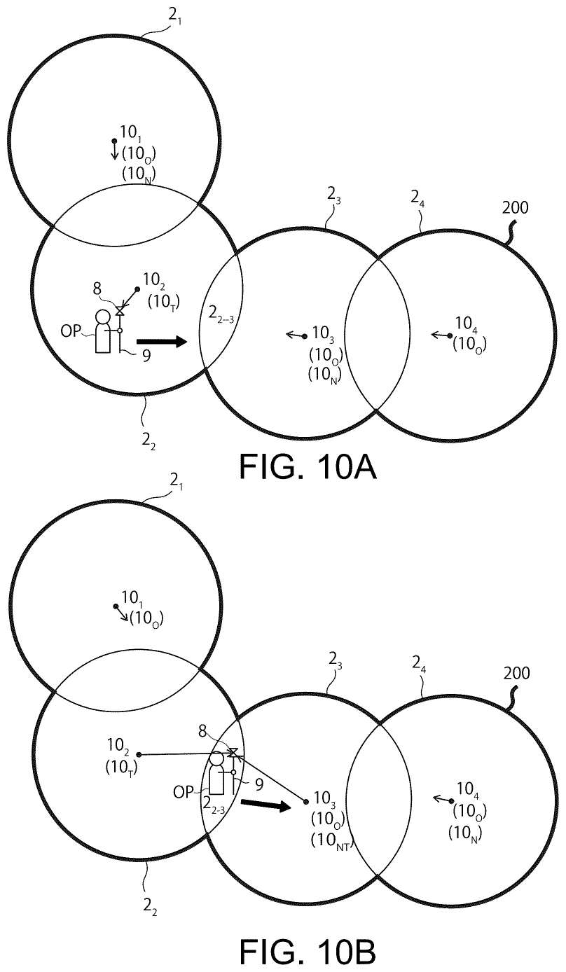

FIGS. 9 and 10 briefly illustrate the second surveying method, which is for surveyance at the site described in FIG. 2B. The operator OP causes a nearby surveying instrument (e.g. surveying instrument 10₁) to lock onto the prism 8 to start automatic tracking (FIG. 9A). Among the multiple surveying instruments 10, the surveying instrument 10ₙ tracking the prism 8 at that time will hereinafter be referred to as a tracking surveying instrument 10_{T}, and the surveying instruments other than the tracking surveying instrument 10_{T} will be referred to collectively as other surveying instruments 10_{O}. The other surveying instruments 10_{O} rotate toward the prism 8 as indicated by the arrow originating from each surveying instrument 10ₙ. The operator OP moves while measuring a measurement point (not depicted) along a survey area SA as described in FIG. 2B. When the operator OP reaches the measurement point and input instructions to measure the prism 8 at the measurement point via the terminal device 80, the tracking surveying instrument 10_{T} measures the prism 8.

When the operator OP travels within the measurement range 2₁ and enters the measurement range 2₂ of the adjacent surveying instrument 10₂ (the surveying instrument adjacent to the tracking surveying instrument 10_{T} will hereinafter be referred to as an adjacent surveying instrument 10_{N}), the surveying instrument 10₂ locks onto the prism 8. That is, both of the surveying instrument 10₁ and the surveying instrument 10₂ lock onto the prism 8 in the overlapping region 2₁₋₂ (FIG. 9B). The adjacent surveying instrument 10_{N} at this time will be referred to as a concurrently tracking adjacent surveying instrument 10_{NT}.

When the operator OP exits the overlapping region 2₁₋₂ and travels deeper into the measurement range 2₂, the surveying instrument 10₁ fails to lock onto the prism 8 and only the surveying instrument 10₂ continues locking onto the prism 8 as a new tracking surveying instrument 10_{T} (FIG. 10A). When the operator OP further moves to enter the overlapping region 2₂₋₃ between the measurement range 2₂ of the surveying instrument 10₂ and the measurement range 2₃ of the surveying instrument 10₃, which is now a new adjacent surveying instrument 10_{N}, the surveying instrument 10₃ begins locking onto the prism 8, so that both of the surveying instrument 10₂ and the surveying instrument 10₃ lock onto the prism 8 in the overlapping region 2₂₋₃ (FIG. 10B). Such a surveying method with a surveying system S enables any one of the multiple surveying instruments 10 to automatically track and measure the prism 8 while the prism 8 moves within the virtual measurement range 200.

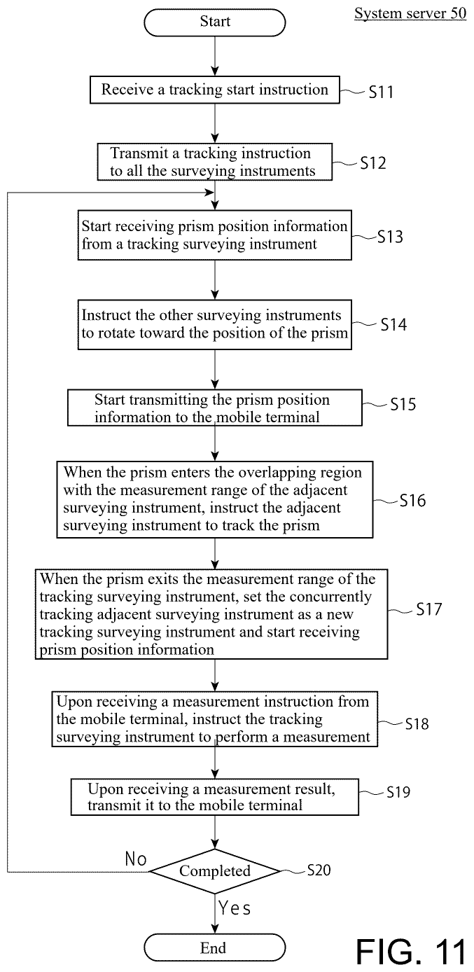

FIGS. 11, 12, 13 are flowcharts of processing by the system server 50, the surveying instrument 10, and the terminal device 80 when the surveying system 10 implements the second surveying method. When the operator OP inputs an instruction of automatic tracking via the terminal device 80 to start surveyance, the system control unit 510 receives a tracking start instruction from the terminal device 80 (S11). Then, the system control unit 510 transmits a tracking instruction to the multiple surveying instruments 10 utilizing a coordinate system common to the multiple surveying instruments 10 (S12).

The system control unit 510 then starts receiving prism position information from the tracking surveying instrument 10_{T} that has successfully tracked the prism 8 among the multiple surveying instruments 10 (S13). The system control unit 510 also starts transmitting the prism position information to the other surveying instruments 10_{O} to instruct them to always face the prism 8 (S14).

At the same time, the system control unit 510 also starts transmitting the prism position information to the terminal device 80 (S15). Next, when the prism 8 enters the overlapping region 2_{T-N} between the measurement range 2_{T} of the tracking surveying instrument 10_{T} and the measurement range 2_{N} of the adjacent surveying instrument 10_{N}, the system control unit 510 transmits a tracking instruction to the adjacent surveying instrument 10_{N} to cause it to start tracking (S16).

When the prism 8 then exits the overlapping region 2_{T-N} and enters an area that only the concurrently tracking adjacent surveying instrument 10_{NT} covers, the system control unit 510 set the concurrently tracking adjacent surveying instrument 10_{NT} as a new tracking surveying instrument 10_{T} and cause it to start transmitting prism position information (S17). This switches the prism position information to be transmitted to the other surveying instruments 10_{O} to the information originating from the surveying instrument that has newly become the tracking surveying instrument 10_{T}. At the same time, the system control unit 510 sets the previous tracking surveying instrument 10_{T} to the other surveying instruments 10_{°}. Until the system control unit 510 receives a termination instruction from the terminal device 80 is at the step S20, the steps S13 to S20 are then repeated.

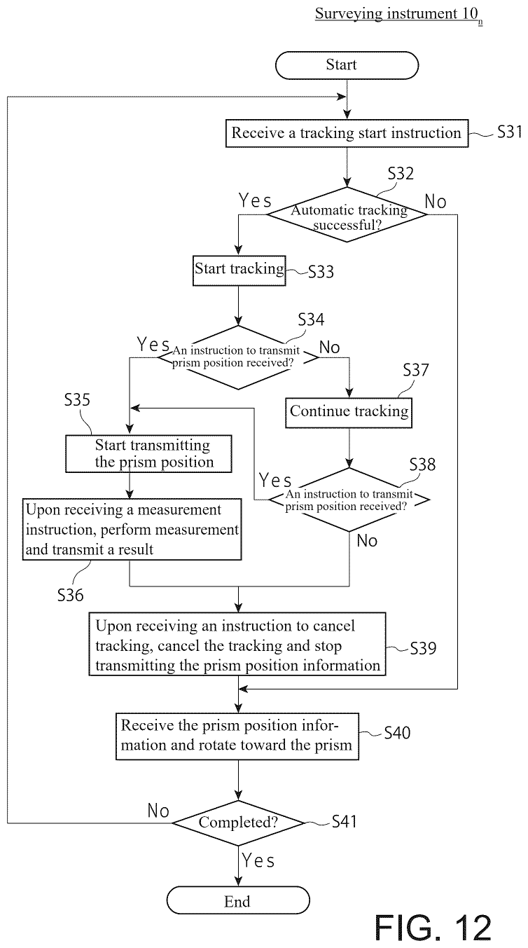

As depicted in FIG. 12, the surveying instrument control unit 29 starts processing when receiving a tracking start instruction on the prism 8 from the system server 50 (S31). In response thereto, the surveying instrument control unit 29 starts a prism search and once successful (S32), begins tracking (S33). In addition, the surveying instrument control unit 29 determines whether it has received an instruction to transmit prism position information (S34). If Yes, the surveying instrument 10ₙ, as a tracking surveying instrument 10_{T}, starts transmitting position information of the prism 8 at predetermined intervals (S35).

When the surveying instrument 10ₙ that is serving as the tracking surveying instrument 10_{T} receives a measurement instruction from the system server 50 during tracking, the surveying instrument control unit 29 automatically collimates the prism 8 to measure it and then transmits a measurement result to the system server 50 (S36). On the other hand, if the surveying instrument 10ₙ receives no instruction to transmit prism position information as another surveying instrument has already been tracking the prism 8 (No in S34), the surveying instrument 10ₙ tracks the prism 8 as the concurrently tracking adjacent surveying instrument 10_{NT} without transmission of position information (S37). Then, when the surveying instrument 10ₙ that is serving as the concurrently tracking adjacent surveying instrument 10_{NT} receives an instruction to transmit prism position information from the system server 50 (Yes in S38), the processing proceeds to S35.

Then, when receiving an instruction to cancel tracking from the system server 50 during tracking of the prism 8, the surveying instrument control unit 29 cancels tracking and stops transmitting the prism position (S39). Then, the surveying instrument 10n, as one of the other surveying instruments 10_{°}, starts to rotate toward the prism 8 based on the prism position information received from the system server 50 (S40). Then, until the surveying instrument 10ₙ receives an instruction to terminate the surveyance from the system server 50 (S41), the surveying instrument control unit 29 repeats the steps S31 to S41.

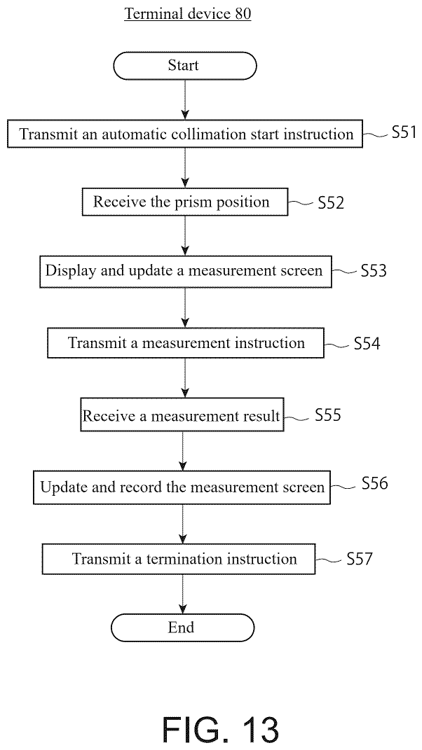

As depicted in FIG. 13, when starting the second surveying method, the terminal control unit 85 transmits an automatic-collimation start instruction to the system server 50 according to an input by the operator OP (S51). This causes the terminal device 80 to receive prism position information as data in the common coordinate system from the tracking surveying instrument 10_{T} via the system server 50. The terminal control unit 85 receives the prism position information at a predetermined interval (S52). The terminal control unit 85 then displays and updates a measurement screen on the terminal display unit 82 based on the prism position information (S53). The terminal control unit 85 then transmits a measurement instruction to the system server 50 according to an input by the operator OP (S54). Next, the terminal control unit 85 receives the measurement result managed in the common coordinate system from the system server 50 (S55). Next, the terminal control unit 85 updates the measurement screen and records the measurement result (S56). For terminating the measurement, the terminal control unit 85 transmits the termination instruction to the system server 50 according to an input by the operator OP (S57), and the processing is completed.

It is noted that the flowcharts have been described with the tracking surveying instrument 10_{T} and the adjacent surveying instrument 10_{N} one-on-one for the sake of explanatory convenience. However, as depicted in FIG. 2D, for example, multiple adjacent surveying instruments may be arranged with respect to one surveying instrument 10ₙ. The system control unit 510 manages each surveying instrument 10ₙ in association with the ID. Accordingly, in this instance, a step of determining each surveying instrument 10ₙ and its adjacent surveying instruments 10_{N} for each of the multiple adjacent surveying instruments 10_{N} is performed.

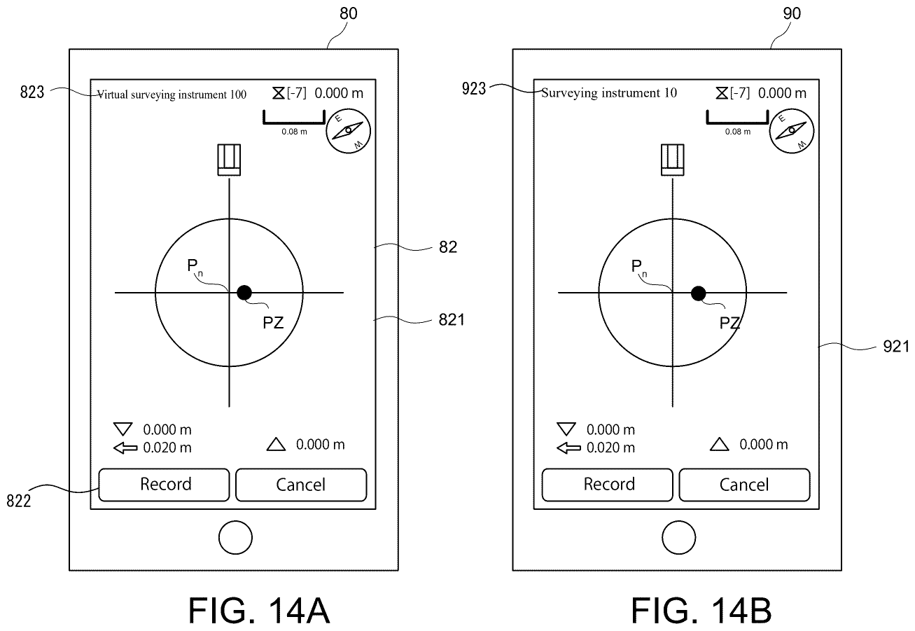

FIG. 14A depicts an example of a measurement screen 821 on the terminal display unit 82 while the second surveying method is implemented. The measurement screen 821 is for guiding the operator OP to the next measurement point. In particular, the measurement screen 821 displays, at a central part of the screen, the next measurement point Pₙ, which is the destination, as the center of a cross and information such as the positional relationship between the next measurement point Pₙ, and the position PZ of the prism 8 as well as which direction to move, for assisting the operator OP in installing the prism 8 at the next measurement point Pₙ. The measurement screen 821 also displays operation buttons 822, which serve as the terminal input unit 81 at a lower part of the screen. The measurement screen 821 also displays a connected instrument indicator 823 at the upper left of the screen, which indicates that the virtual surveying instrument 100 is connected. The measurement screen 821 displays the position PZ of the prism 8 and the position of the next measurement point Pₙ as data for the virtual surveying instrument 100 managed in the common coordinate system regardless of which surveying instrument is currently tracking the prism 8 as the tracking surveying instrument 10_{T}. FIG. 14B depicts, as a comparative example, a measurement screen 921 during automatic tracking when a terminal device 90 with the same configuration as the terminal device 80 is connected with a single surveying instrument (e.g. surveying instrument 10₁). That is, the measurement screen 821 according to this embodiment has the same user interface as the measurement screen 921 when the terminal device 80 is connected with a single surveying instrument.

### 7. Operational Effects

In accordance with the surveying methods described above, taking the multiple surveying instruments 10 as a single virtual surveying instrument 100 enables successively measuring the whole measurement range 2_{ALL} that the multiple surveying instruments 10 cover. This enables efficient surveyance of a larger area. In addition, since the system control unit 510 is configured to communicate, as the single virtual surveying instrument 100, information with the terminal device 80, the operator can operate the multiple surveying instruments 10 as if operating a single surveying instrument 10ₙ, resulting in a reduction in the operational burden.

The second surveying method, in which the operator OP moves while holding the pole 9 with the prism 8 and causes the surveying instrument 10 to perform automatic tracking for surveyance, eliminates the need for relocation of the surveying instrument during movement or starting automatic tracking for each time of relocation of the surveying instrument, resulting in a particular reduction in the operational burden.

Further, in accordance with the configurations described above, an application program configured for a surveying method with a single surveying instrument can be utilized in the terminal device 80 with no modification. It should be noted that using such a conventional application program is not necessary and a new application program for the virtual surveying instrument 100 may be developed. Using a conventional application program eliminates the need for new development, and the time and cost can be reduced. In addition, since the user interface includes no modification, the operator OP can be free from learning a new operation procedure and thus benefits from a reduction in the operational burden.

The methods are particularly effective at a site where obstacles 99 make it difficult to ensure a line of sight as depicted in FIG. 8A. Such a site may suffer from cumbersome relocation of the surveying instrument during movement, in which the methods can reduce the burden. It is noted that the example configurations described above include the system server 50, which includes the system control unit 510. It should however be noted that the surveying system may be configured such that the surveying instrument control unit 29 of any one of the multiple surveying instruments 10 includes the system control unit 510 while the surveying system does not include the system server 50.

### 8. First Variation

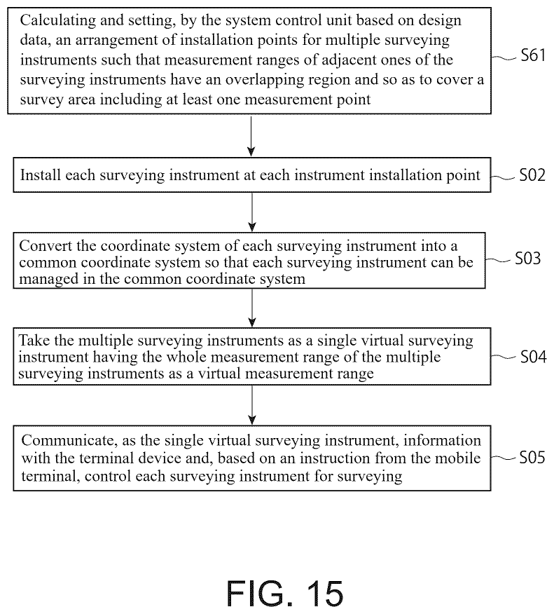

FIG. 15 is a flowchart of a surveying method according to a variation of the first surveying method. The method includes, in place of the step S01, the step S61 of calculating, by the system control unit 510 based on design data for a surveying site, an arrangement of multiple surveying instruments 10 such that measurement ranges of adjacent ones of the multiple surveying instruments have an overlapping region and so as to cover a survey area, to set an arrangement of installation points for the surveying instruments 10ₙ. The design data is a drawing of the surveying site created through three-dimensional or two-dimensional Computer Aided Design (CAD). Provision of the design data enables calculating such an arrangement based on the size of the measurement range 2ₙ of the surveying instrument 10ₙ, the amount of overlapping of adjacent ranges, and the survey area SA. This enables an arrangement of the multiple surveying instruments 10 satisfying the conditions to be set automatically, resulting in a reduction in the operator's time and effort. That is, the variation enables the system control unit 510, when caused to read the design data for the surveying site, to propose installation points for the surveying instruments satisfying the foregoing conditions. It is noted that, at this time, the arrangement is preferably calculated so as to include a minimum number of surveying instruments. This is for the reason that the minimum number of surveying instruments arranged can result in a minimum number of surveying instruments required for surveyance with reduced cost.

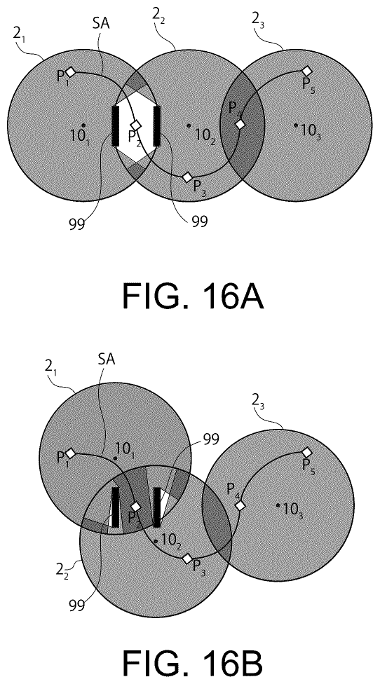

The survey area SA may include an obstacle (e.g. a structure such as a wall or a pillar) that blocks a line of sight to a surveying instrument. In such an instance, even an arrangement that would satisfy the foregoing conditions with no obstacle 99 as depicted in FIG. 16A, for example, may fail to cover the survey area SA set as a curve connecting measurement points P₁ to P₅ due to the obstacles 99. In this instance, three-dimensional design data may be preferably used as the design data in S61 of the variation to propose an arrangement in view of the three-dimensional geometry of the obstacles 99, as depicted in FIG. 16B. The above-described configuration reduces the time and effort on setting installation points. In addition, setting installation points at a site including obstacles can be made easier.

The embodiments of the disclosure, which have heretofore been described with reference to the drawings, are merely illustrative of the disclosure and may employ various configurations other than those described above.

While the multiple steps (processing) are described sequentially in the flowcharts used in the descriptions above, the order of the steps performed in each of the embodiments is not limited to that order described. The order of the steps depicted may be changed as long as the teachings in the embodiments are not affected. Further, the above-described embodiments may be combined to the extent that the teachings will not contradict each other.

Some or all of the above-described embodiments may also be described as in the following appendices, though not limited thereto.
1. A surveying method to be implemented by a system control unit including at least one electronic circuit and capable of communicating with multiple surveying instruments and a terminal device, the surveying method including the steps of: acquiring, by the system control unit, survey data from the multiple surveying instruments and managing the survey data in a common coordinate system, the multiple surveying instruments installed at installation points that are arranged such that measurement ranges of adjacent ones of the surveying instruments have an overlapping region and so as to cover a survey area including at least one measurement point; taking, by the system control unit, the multiple surveying instruments as a single virtual surveying instrument having the whole measurement range of the multiple surveying instruments as a virtual measurement range; and transmitting and receiving, by the system control unit as the virtual surveying instrument, information to and from the terminal device and utilizing the survey data managed in the common coordinate system to control the surveying instruments for surveying.
2. The surveying method according to appendix 1, in which the installation points are arranged such that a line of sight with at least one of the surveying instruments is ensured across the entire survey area, and that lines of sight with two or more of the surveying instruments are ensured in at least a portion of the overlapping region of the measurement ranges of adjacent ones of the surveying instruments.
3. The surveying method according to appendix 2, in which the multiple surveying instruments have a surveying function of measuring the distance and angle to a prism and an automatic tracking function of automatically tracking the prism, the surveying method further including the steps of: during the surveyance, by the system control unit, causing any one of the multiple surveying instruments to track the prism moving within the virtual measurement range to acquire prism position information as a tracking surveying instrument; causing the tracking surveying instrument among the multiple surveying instruments, which tracks the prism, to transmit the prism position information to the system control unit; transmitting the prism position information to the other surveying instruments among the multiple surveying instruments, which are other than the tracking surveying instrument, and causing the other surveying instruments to rotate toward the prism; outputting the prism position information to the terminal device; when the prism enters an overlapping region between the measurement range of the tracking surveying instrument and the measurement range of an adjacent surveying instrument adjacent to the tracking surveying instrument, causing the adjacent surveying instrument to also track the prism; upon receiving a measurement instruction from the terminal device, causing the tracking surveying instrument to measure the prism; and outputting a measurement result on the prism to the terminal device.
4. The surveying method according to any one of appendices 1 to 3, in which the terminal device is installed with an application program for a surveying method with a single surveying instrument, and the system control unit is configured to transmit and receive the information to and from the terminal device in a manner that data relating to the virtual surveying instrument is made available for use by the application program.
5. The surveying method according to any one of appendices 1 to 4, in which the amount of overlapping of the measurement ranges of the adjacent surveying instruments is set in view of the moving speed of the prism within the survey area.
6. The surveying method according to any one of appendices 1 to 5, further including the step of proposing, by the system control unit, an arrangement of the installation points for the surveying instruments based on design data for the survey area.
7. The surveying method according to appendix 6, in which the design data employs three-dimensional design data, and the arrangement of the installation points is proposed in view of the three-dimensional geometry of an obstacle included in the design data.
8. A surveying program for causing a computer to execute the surveying method according to any one of appendices 1 to 7.
9. A surveying system including: multiple surveying instruments each including a distance-measuring device configured to transmit distance-measuring light and measure the distance to a prism, an angle detector configured to measure the angle in the optical axis direction of the distance-measuring light to measure the angle to the prism, a rotary drive unit configured to rotate the optical axis of the distance-measuring light, a surveying instrument control unit having at least one electronic circuit, and a communication unit; and a system control unit capable of communicating with the multiple surveying instruments and including at least one electronic circuit, in which the system control unit is capable of communicating with a terminal device having a display, in which the system control unit is configured to: acquire survey data from the multiple surveying instruments and manage the survey data in a common coordinate system, the multiple surveying instruments installed at installation points that are arranged such that measurement ranges of adjacent ones of the surveying instruments have an overlapping region and so as to cover a survey area including at least one measurement point; take the multiple surveying instruments as a single virtual surveying instrument having the whole measurement range of the multiple surveying instruments as a virtual measurement range; and transmit and receive, as the virtual surveying instrument, information to and from the terminal device and utilize the survey data managed in the common coordinate system to control the surveying instruments for surveying.

### REFERENCE SIGNS LIST

8: Prism
10: Multiple surveying instruments
10ₙ: Surveying instrument
10_{N}: Adjacent surveying instrument
10_{NT}: Tracking adjacent surveying instrument
10_{°}: Other surveying instruments
10_{T}: Tracking surveying instrument
10ₙ: Surveying instrument
24: Tracking unit
80: Terminal device
95: Surveying instrument
100: Virtual surveying instrument
510: System control unit

1. A surveying method to be implemented by a system control unit including at least one electronic circuit and capable of communicating with a plurality of surveying instruments and a terminal device, the surveying method comprising the steps of:
acquiring, by the system control unit, survey data from the plurality of surveying instruments and managing the survey data in a common coordinate system, the plurality of surveying instruments installed at installation points that are arranged such that measurement ranges of adjacent ones of the surveying instruments have an overlapping region and so as to cover a survey area including at least one measurement point;
taking, by the system control unit, the plurality of surveying instruments as a single virtual surveying instrument having the whole measurement range of the plurality of surveying instruments as a virtual measurement range; and
transmitting and receiving, by the system control unit as the virtual surveying instrument, information to and from the terminal device and utilizing the survey data managed in the common coordinate system to control the surveying instruments for surveying.

2. The surveying method according to claim 1, wherein the installation points are arranged such that a line of sight with at least one of the surveying instruments is ensured across the entire survey area, and that lines of sight with two or more of the surveying instruments are ensured in at least a portion of the overlapping region of the measurement ranges of adjacent ones of the surveying instruments.

3. The surveying method according to claim 2, wherein the plurality of surveying instruments have a surveying function of measuring the distance and angle to a prism and an automatic tracking function of automatically tracking the prism, the surveying method further comprising the steps of: during the surveyance, by the system control unit,
causing any one of the plurality of surveying instruments to track the prism moving within the virtual measurement range to acquire prism position information as a tracking surveying instrument;
causing the tracking surveying instrument among the plurality of surveying instruments, which tracks the prism, to transmit the prism position information to the system control unit;
transmitting the prism position information to the other surveying instruments among the plurality of surveying instruments, which are other than the tracking surveying instrument, and causing the other surveying instruments to rotate toward the prism;
outputting the prism position information to the terminal device;
when the prism enters an overlapping region between the measurement range of the tracking surveying instrument and the measurement range of an adjacent surveying instrument adjacent to the tracking surveying instrument, causing the adjacent surveying instrument to also track the prism;
upon receiving a measurement instruction from the terminal device, causing the tracking surveying instrument to measure the prism; and
outputting a measurement result on the prism to the terminal device.

4. The surveying method according to claim 1, wherein the terminal device is installed with an application program for a surveying method with a single surveying instrument, and the system control unit is configured to transmit and receive the information to and from the terminal device in a manner that data relating to the virtual surveying instrument is made available for use by the application program.

5. The surveying method according to claim 3, wherein the terminal device is installed with an application program for a surveying method with a single surveying instrument, and the system control unit is configured to transmit and receive the information to and from the terminal device in a manner that data relating to the virtual surveying instrument is made available for use by the application program.

6. The surveying method according to claim 3, wherein the amount of overlapping of the measurement ranges of the adjacent surveying instruments is set in view of the moving speed of the prism within the survey area.

7. The surveying method according to claim 1, further comprising the step of proposing, by the system control unit, an arrangement of the installation points for the surveying instruments based on design data for the survey area.

8. The surveying method according to claim 3, further comprising the step of proposing, by the system control unit, an arrangement of the installation points for the surveying instruments based on design data for the survey area.

9. The surveying method according to claim 7, wherein the design data employs three-dimensional design data, and the arrangement of the installation points is proposed in view of the three-dimensional geometry of an obstacle included in the design data.

10. The surveying method according to claim 8, wherein the design data employs three-dimensional design data, and the arrangement of the installation points is proposed in view of the three-dimensional geometry of an obstacle included in the design data.

11. A non-transitory computer readable storage medium including a surveying program for causing a computer to execute the surveying method according to claim 1.

12. A non-transitory computer readable storage medium including a surveying program for causing a computer to execute the surveying method according to claim 3.

13. A surveying system comprising:
a plurality of surveying instruments each comprising a distance-measuring device configured to transmit distance-measuring light and measure the distance to a prism, an angle detector configured to measure the angle in the optical axis direction of the distance-measuring light to measure the angle to the prism, a rotary drive unit configured to rotate the optical axis of the distance-measuring light, a surveying instrument control unit having at least one electronic circuit, and a communication unit; and
a system control unit capable of communicating with the plurality of surveying instruments and comprising at least one electronic circuit, wherein the system control unit is capable of communicating with a terminal device having a display, wherein
the system control unit is configured to:
acquire survey data from the plurality of surveying instruments and manage the survey data in a common coordinate system, the plurality of surveying instruments installed at installation points that are arranged such that measurement ranges of adjacent ones of the surveying instruments have an overlapping region and so as to cover a survey area including at least one measurement point;
take the plurality of surveying instruments as a single virtual surveying instrument having the whole measurement range of the plurality of surveying instruments as a virtual measurement range; and
transmit and receive, as the virtual surveying instrument, information to and from the terminal device and utilize the survey data managed in the common coordinate system to control the surveying instruments for surveying.
